(19) United States
(12) Patent Application Publication
(10) Pub. No.: US 2026/0310519 A1
(43) Pub. Date: Oct. 8, 2026

(54) RESOURCE SCHEDULING METHOD, CHIP SYSTEM, ELECTRONIC DEVICE, AND VEHICLE

(71) Applicant: XG TECH PTE. LTD., Singapore (SG)

(72) Inventors: Lei WEI, Singapore (SG); Weicong REN, Singapore (SG)

(73) Assignee: XG TECH PTE. LTD., Singapore (SG)

(21) Appl. No.: 19/176,425

(22) Filed: Apr. 11, 2025

(30) Foreign Application Priority Data
Aug. 20, 2024 (CN) 202411146879.0

(51) Int. Cl. G06F 9/50

(52) U.S. Cl. CPC G06F 9/505

(57) ABSTRACT

Embodiments of this disclosure relate to the technical field of intelligent driving, and provide a resource scheduling method and apparatus, a chip system, an electronic device, and a vehicle. The method includes: determining a first user scenario for a first operating system; and determining, based on the first user scenario, a resource scheduling strategy for scheduling first resources between the first operating system and a second operating system. The first resources can include resources shared by the first operating system and the second operating system. The first operating system can be a cockpit system, and the second operating system can be an intelligent driving system. Alternatively, the first operating system can be an intelligent driving system, and the second operating system can be a cockpit system.

### RELATED APPLICATION INFORMATION

This disclosure claims priority to Chinese patent application No. 2024111468790, filed on Aug. 20, 2024, which is incorporated herein by reference in its entirety.

### FIELD OF THE INVENTION

This disclosure relates to the technical field of intelligent driving, and in particular, to a resource scheduling method and apparatus, a chip system, an electronic device, and a vehicle.

### BACKGROUND OF THE INVENTION

There may be a plurality of operating systems running in an intelligent connected car, such as an intelligent driving system and a cockpit system. The intelligent driving system is mainly responsible for autonomous driving and safety of a vehicle, including environmental perception, path planning, decision-making and control. The cockpit system is mainly responsible for driving experience and human-machine interaction inside the vehicle, including information entertainment, instrument display, media playback, and environmental control.

Currently, resource scheduling of each operating system is isolated, which may result in unreasonable resource allocation, low resource utilization, and other problems. For example, when the intelligent driving system requires more resources for complex path planning, the cockpit system may exactly have idle resources, but these idle resources cannot be utilized by the intelligent driving system. Thus, system resource utilization is reduced.

### SUMMARY OF THE INVENTION

To improve resource utilization among a plurality of operating systems, embodiments of this disclosure provide a resource scheduling method and apparatus, a chip system, an electronic device, and a vehicle.

A first aspect of this disclosure provides a resource scheduling method, which may be applied to an integrated circuit that runs at least a first operating system and a second operating system. The method includes: determining a first user scenario for the first operating system; and determining, based on the first user scenario, a resource scheduling strategy for scheduling first resources between the first operating system and the second operating system. The first resources include resources shared by the first operating system and the second operating system.

For example, the first operating system is a cockpit system, and the second operating system is an intelligent driving system. Alternatively, the first operating system is an intelligent driving system, and the second operating system is a cockpit system.

A second aspect of this disclosure provides a resource scheduling apparatus, which may be applied to an integrated circuit that runs at least a first operating system and a second operating system. The apparatus includes: a scenario recognition unit, configured to determine a first user scenario for the first operating system; and a scheduling management unit, configured to determine, based on the first user scenario, a resource scheduling strategy for scheduling first resources between the first operating system and the second operating system. The first resources include resources shared by the first operating system and the second operating system.

A third aspect of this disclosure provides a chip system, which includes a memory and a processor. The memory stores computer program instructions, and when the computer program instructions are executed by the processor, the chip system is enabled to perform steps of the resource scheduling method according to the first aspect of this disclosure and various implementations thereof.

A fourth aspect of this disclosure provides an electronic device, which may include the chip system according to the third aspect of this disclosure.

A fifth aspect of this disclosure provides a vehicle, which may include the chip system according to the third aspect of this disclosure or the electronic device according to the fourth aspect of this disclosure.

According to technical solutions provided in the embodiments of this disclosure, resource scheduling can be performed between different operating systems based on user scenarios of each operating system. In other words, cross-system resource scheduling based on the user scenarios can be implemented, which not only meets resource demands of each operating system in different user scenarios, thereby improving operational stability of the operating system; but also makes resource allocation more reasonable, thereby improving resource utilization.

### BRIEF DESCRIPTION OF THE DRAWINGS

By describing embodiments of this disclosure more detailed with reference to accompanying drawings, the foregoing and other objectives, features, and advantages of this disclosure will become more apparent. The accompanying drawings are used to provide further understanding of the embodiments of this disclosure, constitute a part of the specification, are used to explain this disclosure together with the embodiments of this disclosure, and do not constitute limitation to this disclosure. In the accompanying drawings, same reference numerals generally represent same components or steps.

FIG. 1 is an architecture diagram of software and hardware of a cockpit-integrated driving system according to an exemplary embodiment of this disclosure;

FIG. 2 is a flowchart of a resource scheduling method according to an exemplary embodiment of this disclosure;

FIG. 3 is a flowchart of step S200 in a resource scheduling method according to an exemplary embodiment of this disclosure;

FIG. 4 is another flowchart of a resource scheduling method according to an exemplary embodiment of this disclosure;

FIG. 5 is a flowchart of step S250 in a resource scheduling method according to an exemplary embodiment of this disclosure;

FIG. 6 is a decision flowchart of a first scheduling strategy according to an exemplary embodiment of this disclosure;

FIG. 7 is a schematic diagram of execution of a first scheduling strategy according to an exemplary embodiment of this disclosure;

FIG. 8 is another schematic diagram of execution of a first scheduling strategy according to an exemplary embodiment of this disclosure;

FIG. 9 is a schematic diagram of execution of a second scheduling strategy according to an exemplary embodiment of this disclosure; and

FIG. 10 is a block diagram of a structure of a resource scheduling apparatus according to an exemplary embodiment of this disclosure.

### DETAILED DESCRIPTION OF THE EMBODIMENTS

Exemplary embodiments of this disclosure are described below in detail with reference to accompanying drawings. Obviously, the embodiments described are merely some, rather than all of embodiments of this disclosure. It should be understood that this disclosure is not limited by the exemplary embodiments described herein.

It should be noted that unless otherwise specified, the scope of this disclosure is not limited by relative arrangement, numeric expressions, and numerical values of components and steps described in these embodiments.

### Application Overview

Intelligent connected cars are a type of vehicles that integrate advanced sensors, controllers, actuators, and communication systems, and can implement functions such as autonomous driving, vehicle networking, and in-vehicle entertainment. The intelligent connected cars collect and analyze large amounts of data to achieve safe, efficient, comfortable, and entertaining driving experience.

The intelligent connected car contains rich driving and entertainment functions. To realize these functions, there are a plurality of operating systems running in the intelligent connected car, such as an intelligent driving system and a cockpit system.

The intelligent driving systems may implement autonomous driving and safety related functions for a vehicle (such as a car). The functions of the intelligent driving system include but are not limited to environmental perception, path planning, decision-making and control, so as to implement the autonomous driving related functions for the vehicle, such as urban/highway autonomous driving, urban/highway navigate on autopilot (NOA), valet parking, automatic parking, adaptive cruise control (ACC), lane centering control (LCC), and related functions for implementing autonomous emergency braking (AEB).

The cockpit system may implement functions related to driving experience and human-machine interaction inside the vehicle. The functions of the cockpit system include but are not limited to information entertainment, instrument display, and/or human-machine interaction.

In some implementations, the intelligent driving system and the cockpit system may run on different chip systems, respectively. For example, the intelligent connected car may include two chip systems, on one of which runs the intelligent driving system and on one of the other runs the cockpit system. Each operating system runs independently and may separately schedule resources provided by a chip system in which this operating system is located. In other words, system scheduling of the intelligent driving system and the cockpit system is isolated from each other, and resources cannot be shared between the operating systems. In other words, cross-system scheduling of resources cannot be implemented, resulting in unreasonable resource allocation and low utilization. For example, when the intelligent driving system requires more resources for complex path planning, the cockpit system may exactly have idle resources, but these idle resources cannot be utilized by the intelligent driving system. Thus, resource utilization is reduced.

### Exemplary System

An embodiment of this disclosure provides a cockpit-integrated driving system.

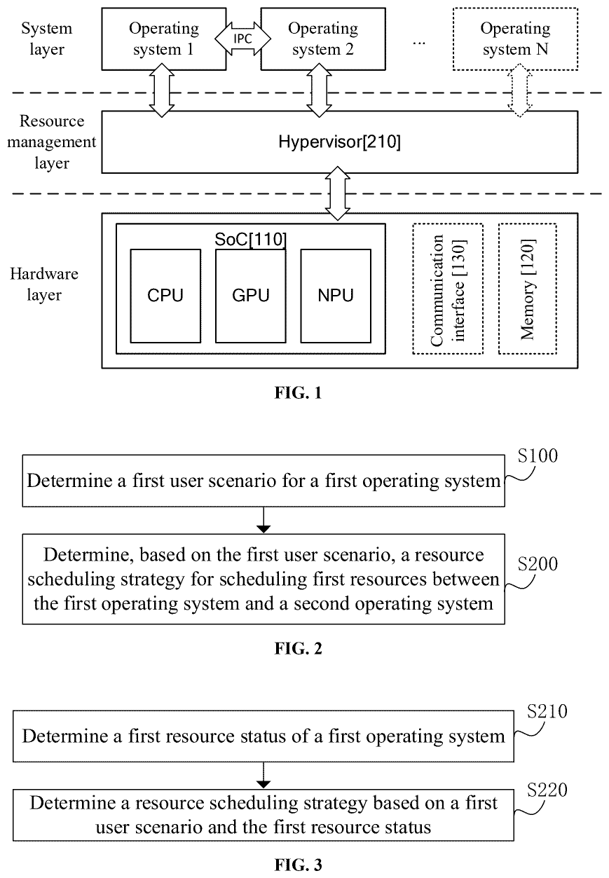

FIG. 1 is an architecture diagram of software and hardware of a cockpit-integrated driving system according to an exemplary embodiment of this disclosure.

In this embodiment of this disclosure, the cockpit-integrated driving system may be applied to vehicles. The vehicles may include land vehicles, aerial vehicles, maritime vehicles, underwater vehicles, space vehicles, and the like.

The land vehicles may include, for example, motorized vehicles (such as an intelligent connected car, a trolleybus, and a bus), rail vehicles (such as a train, a subway, and a tram), various types of mobile robots (such as a service robot, a transport robot, an autonomous guided vehicle (AGV), an unmanned ground vehicle (UGV), and a biomimetic robot (such as a robotic dog)), various engineering machinery, and other movable land devices. The aerial vehicles may include, for example, airplanes, low-altitude aircraft, high-altitude aircraft, flying cars, and drones. The maritime vehicles may include ships, speedboats, and the like. The underwater vehicles may include submarines, submersibles, underwater detectors, and the like. The space vehicles may include spacecraft, space shuttles, artificial satellites, and the like.

In some examples, the vehicle may be a human-driven vehicle, that is, a manned vehicle; or may be a driverless vehicle, that is, an unmanned vehicle.

In this embodiment of this disclosure, the cockpit-integrated driving system is a comprehensive system that integrates the cockpit system and the intelligent driving system. Compared to the independent cockpit system and intelligent driving system, the cockpit-integrated driving system has higher degrees in integration and intelligence, being helpful in improving driving safety, comfort, and driving experience of a mobile vehicle. In an embodiment, the cockpit-integrated driving system may include a hardware layer, a resource management layer, and a system layer.

The hardware layer includes a hardware part of the cockpit-integrated driving system, such as an integrated circuit, which may be a chip system, such as a system on chip (SoC) 110. For example, the SoC 110 may include one or more central processing units (CPUs), and/or one or more graphics processing units (GPUs), and/or one or more neural processing units (NPUs), a digital signal processor (DSP), and an image signal processor (ISP). These processors may be used to provide resources to the system layer, such as provide computing power resources to the cockpit system and the intelligent driving system, so as to support the cockpit system and the intelligent driving system to implement functions thereof.

In this embodiment of this disclosure, the resources refer to a catchall term for various hardware on the integrated circuit (such as the SoC) for performing tasks, running programs, and providing computing power. For example, the resources may include processor resources (such as CPU resources and GPU resources), memory resources, storage resources, network resources, and input/output (I/O) resources.

In an implementation, each processor, such as a CPU, a GPU, or an NPU, may also be an independent device. In other words, different processors may be located on different chips. Alternatively, at least one processor may be integrated on one chip, and at least one other processor may be integrated on another chip. This is not limited in this embodiment of this disclosure.

In addition to the SoC 110, the hardware layer may also include other hardware, such as a memory 120 and a communication interface 130.

The memory 120 may be used for system files, application files, data files (such as cached data and high-precision map data) of the intelligent driving systems and the cockpit systems. For example, the memory 120 may include a volatile memory such as a dynamic random access memory (DRAM) or a static random access memory (SRAM); and may also include a non-volatile memory (NVM), such as a read-only memory (ROM) or a flash memory. In some examples, the memory 120 may be a discrete device; or may be integrated, for example on one SoC, with at least some components (such as at least some processors) of the chip system. Some memories 120 (such as cache) may also be integrated inside the processor as a part of the processor.

In this embodiment of this disclosure, the memory 120 further stores computer program instructions. When the computer program instructions are executed by the processor, the chip system is enabled to perform steps of a resource scheduling method provided in embodiments of this disclosure.

The communication interface 130 is used for communication between hardware layers and between the hardware layer and other devices such as a sensor, a display screen, a microphones, and a loudspeaker of the vehicle. For example, the communication interface 130 may include a controller area network (CAN) interface, an integrated circuit (inter-integrated circuit, I2C) interface, an inter-integrated circuit sound (12S) interface, a pulse code modulation (PCM) interface, a digital video port (DVP), a peripheral component interconnect express (PCI-E) interface, a serial peripheral interface (serial peripheral interface bus, SPI), a universal asynchronous receiver/transmitter (UART) interface, a mobile industry processor interface (MIPI), a general-purpose input/output (GPIO) interface, a local interconnect network (LIN) interface, a FlexRay interface, a media oriented systems transport (MOST) interface, and an Ethernet interface. In an implementation, the communication interface 130 may be integrated onto the SoC as a part of the SoC, to improve system integration.

The system layer may include a plurality of operating systems, such as an operating system 1, an operating system 2 . . . and an operating system N. Different operating systems may be used to implement different functions of the cockpit-integrated driving system. The plurality of operating systems may run in the integrated circuit, or in other words, may run in the chip system.

The plurality of operating systems may be constructed based on a same system kernel, which facilitates data exchange and sharing between the plurality of operating systems. Certainly, the plurality of operating systems may also be constructed based on different system kernels, so as to select a more suitable operating system according to actual requirements. The system kernel may be, for example, a microkernel, a macro kernel, a hybrid kernel, or an external kernel. For example, taking that the system layer includes the operating system 1 and the operating system 2 as an example, the operating system 1 and the operating system 2 may be same or different operating systems among a real-time operating system (RTOS), a unix real-time operating system (quick unix, QUX), a linux operating system, and an android operating system. For example, the operating system 1 is a linux operating system, and the operating system 2 is an android operating system.

In an implementation, the operating system 1 may be a cockpit system, for implementing functions related to driving experience and human-machine interaction inside the vehicle. The operating system 2 may be an intelligent driving system, for implementing autonomous driving and safety related functions for the vehicle. Alternatively, the operating system 1 may be an intelligent driving system, and the operating system 2 may be a cockpit system. In other words, when the system layer includes a plurality of operating systems, implementation of each operating system is not limited in this embodiment of this disclosure.

In an implementation, there may also be an interconnect interface between at least two operating systems, such as an inter-process communication (IPC) interface. In this way, different operating systems may communicate with each other through the IPC interface, so as to send and receive messages and share information. For example, different operating systems may share load information, temperature information, and computing power requirements through the IPC interface. This is not specifically limited in this embodiment of this disclosure.

In an implementation, at least one operating system may include a plurality of subsystems. Taking the cockpit system as an example, the cockpit system may include a plurality of subsystems, and a quantity and functions of the subsystems in the cockpit system may be determined based on configuration of a cockpit. For example, taking that the cockpit contains a dashboard, a center control panel, and a passenger screen as an example, the cockpit system may include, for example, a dashboard subsystem, a center control panel subsystem, and a passenger screen subsystem. The dashboard subsystem may be used to display key information of the vehicle on the dashboard, such as a speed, a rotational speed, fuel consumption, power consumption, temperature, warning messages, navigation instructions, a status of an assisted driving system, and vehicle fault warnings. The center control panel subsystem may be used to provide infotainment functions for the vehicle, such as audio playback, video playback, a navigation system, Bluetooth connection, and mobile phone screen casting; provide vehicle setting functions, such as adjusting air conditioners, seats, lighting, driving modes, and power output configuration; provide assisted driving related functions for the vehicle, such as displaying vehicle backup images, displaying 360-degree panoramic images, and displaying relevant information obtained from other operating systems (such as the intelligent driving systems); and provide human-machine interaction functions for the vehicle, such as voice control and gesture control. The passenger screen subsystem may be used to provide entertainment or information services for a front seat passenger, such as playing music and videos, providing game content, and displaying navigation information.

In some examples, the cockpit system may allocate resources obtained by itself to each subsystem for use, and may schedule the resources of each subsystem based on an execution status and load and/or resource demands of each subsystem. For example, if detecting that a driver is using the dashboard to view the navigation information, the cockpit system may allocate more resources to the dashboard subsystem. For another example, if detecting that the front seat passenger is using the passenger screen to watch a video, the cockpit system may allocate more resources to the passenger screen subsystem.

The resource management layer is an intermediate layer located between the hardware layer and the system layer, and may be implemented by software, or hardware, or a combination of software and hardware. The resource management layer is used to allocate the resources on the hardware layer to the system layer for use, for example, allocate some of the resources to the operating system 1 for use, and allocate the other resources to the operating system 2 for use.

In an implementation, at least some of the resources on the hardware layer may be allocated to both the operating system 1 and the operating system 2 for use. In other words, at least some of the resources on the hardware layer may be shared by the operating system 1 and the operating system 2, and the shared resources may be scheduled between the operating system 1 and the operating system 2. For ease of description, the resources shared by the operating system 1 and the operating system 2 may be referred to as first resources hereinafter.

In an example, the first resources may include all the resources on the hardware layer, such as all CPU resources, all GPU resources, all NPU resources, and all I/O resources. In other words, all the resources on the hardware layer are shared by the operating system 1 and the operating system 2. Taking CPU resources in the SoC as an example, assuming that the CPU has 8 cores, these 8 cores may be allocated to either the operating system 1 or the operating system 2.

In another example, the first resources may include some of the resources on the hardware layer, such as some of the CPU resources, some of the GPU resources, some of the NPU resources, and some of the I/O resources. To be specific, some of the resources on the hardware layer are non-shared resources and can merely be allocated to the operating system 1 or the operating system 2, while the other resources are shared resources and can be allocated to both the operating system 1 and the operating system 2.

Taking the CPU resources in the SoC as an example, it is assumed that the CPU has 8 cores, such as cores 1 to 8. The cores 1 and 2 are non-shared resources, where the core 1 may be allocated to the operating system 1, while the core 2 may be allocated to the operating system 2. The cores 3 to 8 are shared resources, that is, the first resources, which may be allocated to both the operating system 1 and the operating system 2. The first resources may be fixedly or dynamically adjusted. For example, the cores 1 to 4 may be adjusted as non-shared resources, while the cores 5 to 8 may be adjusted as shared resources.

Alternatively, 20% of the CPU resources are non-shared resources, of which 10% may merely be allocated to the operating system 1, while the remaining 10% may merely be allocated to the operating system 2. The remaining 80% of the CPU resources are shared resources, that is, the first resources, which may be allocated to both the operating system 1 and the operating system 2. The 80% of the CPU resources may be virtualized CPU resources. In other words, the 80% of the CPU resources do not correspond to one or some cores of the CPU. Certainly, the 80% of the CPU resources may also be provided by designated cores of the CPU, for example, may be provided by the cores 3 to 8.

In an implementation, the resource management layer may virtualize the resources on the hardware layer, and schedule the virtualized resources to the system layer for use. In other words, the resource management layer may establish and manage a plurality of virtual machine instances based on the resources on the hardware layer, and allocate the resources on the hardware layer to each virtual machine instance. A plurality of operating systems run on different virtual machine instances, respectively.

For example, the resource management layer may include a virtual machine manager hypervisor 210, which may manage the resources on the hardware layer, such as resources of a processor, a memory, and a network; and allocate these resources to the plurality of virtual machine instances, so that the operating systems running in the various virtual machine instances can share these resources and run in isolated virtual environments, thereby ensuring that the operating systems do not interfere with each other and improving security and reliability of the cockpit-integrated driving system. In addition, the hypervisor 210 may also coordinate requests from various operating systems, map these requests to physical hardware on the hardware layer, and return a processing result to the corresponding operating system. In addition, the hypervisor 210 may also schedule the resources between the various virtual machine instances, thereby ensuring efficient utilization of the resources.

It may be understood that the structure illustrated in this embodiment of this disclosure does not constitute a specific limitation on the cockpit-integrated driving system. In some other embodiments of this disclosure, the cockpit-integrated driving system may include more or fewer components than those shown in FIG. 1, or may combine certain components, or may split certain components, or may adopt different component arrangements. The components of FIG. 1 may be implemented by hardware, software, or a combination of software and hardware.

### Exemplary Method

An embodiment of this disclosure provides a resource scheduling method, which may be implemented in a cockpit-integrated driving system shown in FIG. 1, and may also be implemented in other software and hardware systems. For example, this method is applied to an integrated circuit, which runs at least a first operating system and a second operating system.

The first operating system and the second operating system are involved in the embodiments described below. The first operating system and the second operating system may be any one of the two systems in the cockpit-integrated driving system. For example, the first operating system may be a cockpit system, and the second operating system may be an intelligent driving system. Alternatively, the first operating system may be an intelligent driving system, and the second operating system may be a cockpit system.

Correspondingly, the first operating system, the second operating system, and/or a resource management layer may call processors to perform steps of the method provided in this embodiment of this disclosure. For example, some steps of the method are performed by the first operating system through calling a processor, some steps of the method are performed by the second operating system through calling a processor, and some steps of the method are performed by the resource management layer through calling a processor. This may be flexibly designed in specific implementation, and is not limited in this embodiment of this disclosure.

That the first operating system, the second operating system, and/or the resource management layer call the processors to perform the steps of the method provided in this embodiment of this disclosure may also be described as that the steps of the method provided in this embodiment of this disclosure are performed by the first operating system, the second operating system, and/or the resource management layer.

FIG. 2 is a flowchart of a resource scheduling method according to an exemplary embodiment of this disclosure.

As shown in FIG. 2, in some embodiments, the resource scheduling method may include the following steps.

Step S100. Determine a first user scenario for a first operating system.

The first user scenario may be a current user scenario of the first operating system.

In this embodiment of this disclosure, there may be a plurality of manners for setting user scenarios.

In a first implementation, the user scenarios may be set based on statuses of a vehicle. The statuses of the vehicle may include, for example, a driving status and a parking status. For example, the user scenarios may include but are not limited to at least one of the following:
a driving scenario: the vehicle is in a driving status;
a parking scenario: the vehicle is in a parking status;
an intelligent driving scenario: the vehicle is driving and an intelligent driving function is enabled; and
a manned driving scenario: the vehicle is driving and the intelligent driving function is disabled.

In a second implementation, the user scenarios may be classified based on system statuses of the operating system. The system statuses may include, for example, a standby status, a screen-on status, a screen-off status, an active status, and a charging status. For example, the user scenarios include but are not limited to at least one of the following:
a standby scenario: the operating system is in the standby status;
a screen-on status: the operating system is in a standby+screen-on status;
a screen-off scenario: the operating system is in a standby+screen-off status; and
an active scenario: the operating system is playing music, playing a video, or running a game application.

In a third implementation, the user scenarios may be classified based on input statuses of the operating system. The input statuses may include, for example, a touch input status, a voice input status, and a visual input status. For example, the user scenarios include but are not limited to at least one of the following:
a touch scenario: a user is performing a touch operation on a user interface of the operating system;
a voice scenario: the operating system is performing speech recognition; and
a visual scenario: the operating system is performing visual recognition.

In a fourth implementation, the user scenarios may be classified based on application statuses of the operating system. For example, the user scenarios of the operating system include but are not limited to at least one of the following:
a game scenario: the operating system is running a game application;
a video scenario: the operating system is running a video application;
a music scenario: the operating system is running a music application;
a navigation scenario: the operating system is running a map application; and
a downloading scenario: an application of the operating system is downloading content.

In some other implementations, the foregoing manners of classifying the user scenarios may also be combined, so as to form richer user scenarios. For example, if the classification manners in the first implementation and the fourth implementation are combined for use, the user scenarios may further include an intelligent driving+video scenario, a parking+game scenario, and the like.

In some other implementations, the user scenarios may be further split to obtain more user scenarios. For example, the intelligent driving scenario may be further split into a highway intelligent driving scenario, an urban intelligent driving scenario, and an automatic parking scenario.

In some other implementations, the user scenarios may also be aggregated to reduce a quantity of the user scenarios. For example, the touch scenario, the voice scenario, and the visual scenario may be aggregated into an interaction scenario; the intelligent driving scenario and the manned driving scenario may be aggregated into the driving scenario; and the game scenario, the video scenario, the music scenario, the navigation scenario, and the downloading scenario may be aggregated into the active scenario.

The manners of classifying the user scenarios are not specifically limited in this embodiment of this disclosure.

The manners of setting the user scenarios are exemplarily described above. It may be understood that due to the different functions of different operating systems, the user scenarios included in different operating systems may also be different. In addition, the operating system may include more or fewer user scenarios, and the user scenarios may also be classified by using other manners. Certainly, the user may also personalize the configuration of the user scenarios, and the operating system may also update the user scenarios through downloading over the air (OTA) and other manners, so as to constantly enrich the user scenarios. All of these do not go beyond the protection scope of this embodiment of this disclosure.

In an embodiment, step S100 may be performed by the first operating system through calling the processor.

There may be a plurality of manners for the first operation system to determine the first user scenario.

In an implementation, information of an application currently running on the first operating system may be obtained, and the first user scenario may be determined based on the obtained information of the application.

The information of an application may include a name, a package name, and/or a process name of the application currently running in the first operating system. In this way, based on the obtained information of an application, the first operating system may determine which applications are running, so as to determine the first user scenario. For example, an application name of WeChat® may be “WeChat”, a package name thereof may be “com.tencent.xin”, and a process name thereof may be “WeChat.exe”.

For example, if application information of the intelligent driving application is obtained, it may be determined that the intelligent driving application is currently running. In this case, the first application scenario may be determined as the intelligent driving scenario.

Generally, running applications may include an application currently running in foreground and an application currently running in background. The application running in the foreground may be referred to as a foreground application. “Running in the foreground” herein indicates that the application is currently running and displays content on a display screen. In an example, the foreground application may specifically include a foreground focus application and a foreground non-focus application. The foreground focus application includes an application that displays content on the display screen and is being operated by the user, and the foreground non-focus application includes an application that is displayed on the display screen but is not operated by the user. Correspondingly, the application running in the background may be referred to as a background application. “Running in the background” herein indicates that the application is currently running but does not display content on the display screen.

When an application is running in the foreground, it usually means that this application is currently used by the user. For example, when the user watches a video (such as the video scenario), the video application may run in the foreground to play video content. When an application is running in the background, it usually means that this application is currently not being used by the user. For example, when the user is not watching a video, the video application may be switched to run in the background. When navigation is not used by the user, the map application may be switched to run in the background.

It may be learned that the foreground application is more helpful in accurately determining the first user scenario of the first operating system. In this case, in an implementation, information of the foreground application in the first operating system may be obtained, and the first user scenario may be determined based on the obtained information of the foreground application.

In addition, the first operating system allows a plurality of applications to run in the foreground. For example, the first operating system may display interfaces of the plurality of applications simultaneously on the display screen through a split screen, a card window, or a floating window. For example, an interface of the map application and an interface of the music application are displayed simultaneously. In this case, the information of the foreground application obtained by the first operating system may include application information of the plurality of applications. For example, application information of the map application and application information of the music application are included. In this case, there may be a plurality of first user scenarios that are determined by the first operating system. For example, the first user scenarios may include the navigation scenario and the music scenario.

In an implementation, the first user scenario may be determined based on the status of the vehicle. For example, if the vehicle is in the driving status, such as operating at a D gear, it may be determined that the first user scenario is the driving scenario. If the vehicle is in the parking status, such as operating at a P gear, it may be determined that the first user scenario is the parking scenario.

In an implementation, the first user scenario may be determined based on the system status of the first operating system. For example, if the first operating system is in the standby status, it may be determined that the first user scenario is the standby scenario. If the first operating system is in the screen-on status, it may be determined that the first user scenario is the screen-on scenario.

In an implementation, the first user scenario may be determined based on the input status of the first operating system. For example, if the first operating system is in the touch input status, for example, is responding to the touch operation of the user, it may be determined that the first user scenario is the touch scenario. If the first operating system is in the voice input status, for example, is receiving or recognizing user voice, it may be determined that the first user scenario is the voice scenario.

In an implementation, the foregoing manners for determining the first user scenario may also be combined, so that the first user scenario may be further subdivided for resource scheduling at finer granularity. For example, the first user scenario may be determined based on the status of the vehicle and the application status. For example, if the vehicle is in the driving status and the intelligent driving application is running, it may be determined that the first user scenario is the intelligent driving scenario. For another example, if the vehicle is in the driving status and the intelligent driving application is not running, it may be determined that the first user scenario is the manned driving scenario.

Manners for determining the first user scenario are exemplarily described above. It may be understood that the foregoing examples are some but not all examples of determining the first user scenario. In practical applications, other manners for determining the first user scenario may be set based on the manners for classifying the application scenarios and the user scenarios, and functions of the operating system in the embodiments of this disclosure. These other manners do not go beyond the protection scope of the embodiments of this disclosure.

Step S200. Determine, based on the first user scenario, a resource scheduling strategy for scheduling first resources between the first operating system and a second operating system.

In an embodiment, step S200 may be performed by the first operating system through calling the processor.

The first resources include resources shared by the first operating system and the second operating system.

Generally, during initial operation of the chip system, for example, when the chip system is powered on, the resource management layer may initially allocate the first resources to the first operating system and/or the second operating system. The first resources may also have been scheduled during historical operation of the chip system, thereby changing an allocation status of the first resources. Therefore, before step S200 is performed, there may be a plurality of allocation statuses for the first resources, which are exemplarily described below.

First allocation status: The first resources are all allocated to the first operating system and/or the second operating system. For example, 50% of the first resources are allocated to the first operating system, and the remaining 50% of the first resources are allocated to the second operating system. Alternatively, 40% of the first resources are allocated to the first operating system, and the remaining 60% of the first resources are allocated to the second operating system. Alternatively, the first resources are all allocated to the first operating system, and the second operating system does not obtain the first resources. Alternatively, the first resources are all allocated to the second operating system, and the first operating system does not obtain the first resources.

Second allocation status: Only some of the first resources are allocated to the first operating system and/or the second operating system. For example, 40% of the first resources are allocated to the first operating system, other 50% of the first resources are allocated to the second operating system, and the remaining 10% of the first resources are in an unallocated status.

Based on the various allocation statuses of the first resources, there may be a plurality of resource scheduling strategies. Taking scheduling the first resources between the cockpit system and the intelligent driving system as an example, the resource scheduling strategies may include:
a strategy 1: scheduling at least some of the first resources that are already allocated to the cockpit system to the intelligent driving system;
a strategy 2: scheduling at least some of the first resources that are already allocated to the intelligent driving system to the cockpit system;
a strategy 3: scheduling at least some of the non-allocated first resources to the cockpit system; and
a strategy 4: scheduling at least some of the non-allocated first resources to the intelligent driving system.

Considering that resource demands of the cockpit system and the intelligent driving system may vary under different user scenarios, a resource scheduling strategy may be determined based on the first user scenario, and the first resources may be scheduled between the cockpit system and the intelligent driving system by using this resource scheduling strategy, so as to meet the resource demands of the cockpit system and the intelligent driving system under different user scenarios.

Manners for determining the resource scheduling strategy based on the first user scenario are exemplarily described below.

When the first user scenario is the driving scenario, the intelligent driving scenario, or the manned driving scenario, it is needed to preferentially ensure that the intelligent driving system can obtain more resources, so as to ensure that the intelligent driving system can stably provide intelligent driving or vehicle safety related functions, such as autonomous driving, adaptive cruise control, lane centering (lane keeping) control, and automatic emergency braking. In this case, the first resources may be scheduled from the cockpit system to the intelligent driving system. Therefore, the strategy 1 and/or the strategy 4 may be selected.

When the first user scenario is the parking scenario, the intelligent driving system may disable the intelligent driving related functions and enter the standby status or another non-intelligent driving status, with lower requirements for resources. In this case, the first resources may be scheduled from the intelligent driving system to the cockpit system. Therefore, the strategy 2 and/or the strategy 3 may be selected.

According to the resource scheduling method in this embodiment of this disclosure, a cross-system resource scheduling mechanism is provided, so that cross-system resource scheduling can be implemented between the first operating system and the second operating system based on the first user scenario. This not only enables the resources obtained by each operating system to meet demands of the first user scenario, but also makes resource allocation more reasonable, thereby improving resource utilization, and improving operational efficiency and stability of the operating system.

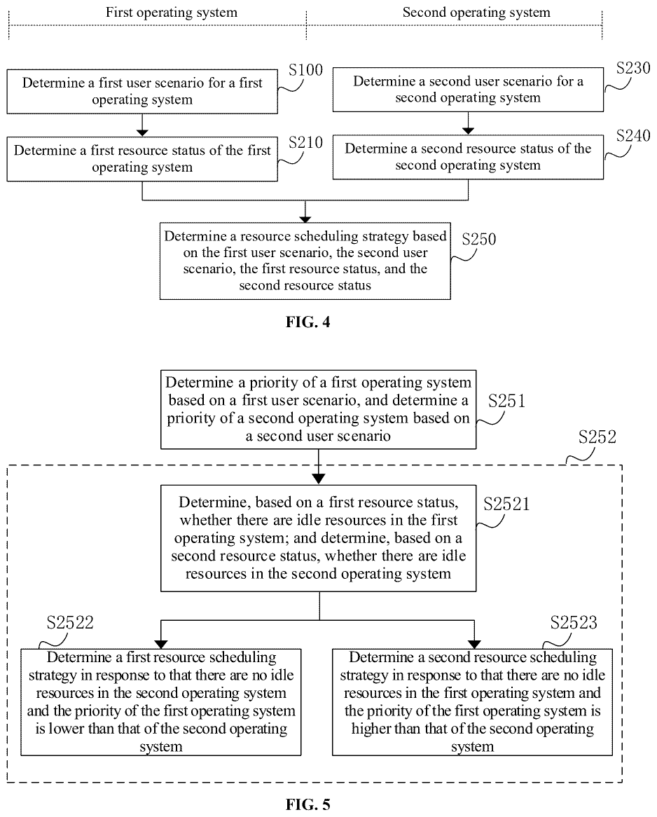

FIG. 3 is a flowchart of step S200 in a resource scheduling method according to an exemplary embodiment of this disclosure.

As shown in FIG. 3, in an embodiment, step S200 may be implemented according to the following steps.

Step S210. Determine a first resource status of the first operating system.

Step S210 may be performed by the first operating system through calling the processor. After determining the first resource status, the first operating system may send the first resource status to the second operating system through an IPC interface.

In an implementation, the first resource status includes a load status of the first operating system, such as a current load. In specific implementation, a performance management tool or a load monitoring tool may run on the first operating system to monitor and obtain the load status of the first operating system. For example, the load status of the first operating system may include usage of resources obtained by the first operating system, such as CPU usage, GPU usage, and NPU usage.

In an implementation, the first resource status may also include load changes of the first operating system in a future period of time. The future period of time may be, for example, a few seconds or minutes in the future, which is not limited in this embodiment of this disclosure. In specific implementation, load changes of the first operating system may be estimated based on the first user scenario, to predict the load changes of the first operating system during the future period of time.

Taking that the first operating system is the cockpit system and the first user scenario is the video scenario as an example, when the video application plays a video with specific resolution, a specific frame rate, and a specific bitrate, resources consumed by the video application may be predicted. Based on this, the load changes of the cockpit system during the future period of time (for example, during a remaining duration before end of video playback) may be predicted. Resources expected to be consumed for playing videos with different resolution, frame rates, and bitrates may be obtained through statistics about local or cloud historical data. This is not specifically limited herein.

Taking that the first operating system is the intelligent driving system and the first user scenario is the intelligent driving scenario as an example, when the intelligent driving application is executing a highway intelligent driving task, resources consumed by the intelligent driving application may be predicted. Based on this, the load changes of the intelligent driving system during the future period of time (for example, during a remaining duration before end of this intelligent driving) may be predicted. Resources expected to be consumed by the highway intelligent driving task may be obtained through statistics about local or cloud historical data. This is not specifically limited herein.

Taking that the first operating system is the intelligent driving system and the first user scenario is the intelligent driving scenario as an example, when the intelligent driving application is executing an urban intelligent driving task, the resources consumed by the intelligent driving application may fluctuate. For example, in a road section/period with fewer vehicles and simple road conditions, such as an urban elevated road/non-rush hours, the intelligent driving application consumes less resources. In a road section/period with more vehicles and complex road conditions, such as an intersection/rush hours, the intelligent driving application consumes more resources. Based on this, a time period during which the vehicle passes through each road section may be estimated based on an intelligent driving route, so that resource consumption of the intelligent driving application in each time period is predicted, so as to predict the load changes of the intelligent driving system during the future period of time (for example, during the remaining duration before the end of this intelligent driving). Resources expected to be consumed by the urban intelligent driving task may be obtained through statistics about local or cloud historical data. This is not specifically limited herein.

In this way, based on the first resource status, the first operating system may determine a proportion of idle resources and a proportion of occupied resources thereof, so as to provide a basis for the determining of the resource scheduling strategy.

Step S220. Determine the resource scheduling strategy based on the first user scenario and the first resource status.

Step S220 may be performed by the first operating system through calling the processor.

For example, the resource scheduling strategy may include scheduling the first resources from the first operating system to the second operating system, or scheduling the first resources from the second operating system to the first operating system.

For example, the first operating system is the cockpit system, and the second operating system is the intelligent driving system.

When the first user scenario is the driving scenario, resource supply of the second operating system needs to be preferentially ensured. In this case, whether resource scheduling needs to be performed may be determined based on the first resource status. If the resource scheduling needs to be performed, the resource scheduling strategy may include scheduling the first resources from the first operating system to the second operating system.

When the first user scenario is the parking scenario, the second operating system may exit the intelligent driving related function. In this case, whether resource scheduling may be performed may be determined based on the first resource status. If the resource scheduling may be performed, the resource scheduling strategy may include scheduling the first resources from the second operating system to the first operating system.

According to the method provided in this embodiment of this disclosure, the resource scheduling strategy is determined based on the user scenario and the resource status of the first operating system, so that it is possible to match the resources obtained by the first operating system to the resource requirements of the first operating system in various user scenarios, so as to ensure that each application in the first operating system can run efficiently and stably, thereby improving system reliability.

FIG. 4 is another flowchart of a resource scheduling method according to an exemplary embodiment of this disclosure.

As shown in FIG. 4, in an embodiment, the resource scheduling method may further include the following steps.

Step S100. Determine a first user scenario for a first operating system.

Step S210. Determine a first resource status of the first operating system.

Step S230. Determine a second user scenario for a second operating system.

The second user scenario may be a current user scenario of the second operating system.

Step S230 may be performed by the second operating system through calling a processor. After determining the second user scenario, the second operating system may send the second user scenario to the first operating system through an IPC interface.

There may be a plurality of manners for the second operating system to determine the second user scenario. For example, information of an application currently running on the second operating system may be obtained, and the second user scenario may be determined based on the obtained information of the application. Information of a foreground application in the second operating system may be obtained, and the second user scenario may be determined based on the obtained information of the foreground application. The second user scenario may be determined based on a status of a vehicle. The second user scenario may be determined based on a system status of the second operating system. The second user scenario may be determined based on an input status of the second operating system.

For content of determining the second user scenario by the second operating system that is not described, please refer to the manner of determining the first user scenario by the first operating system, and details are not described herein.

It may be understood that due to different functions of the first operating system and the second operating system and different applications running on the first operating system and the second operating system, the first user scenario and the second user scenario may be same or different at a same moment or during a same time period.

For example, the first operating system is a cockpit system, and the second operating system is an intelligent driving system:

If the vehicle is in a driving status and a video is being played on the first operating system, the first user scenario determined by the first operating system may be a video scenario, and the second user scenario determined by the second operating system may be a driving scenario.

If the vehicle is in a parking status and a game application is running on the first operating system, the first user scenario determined by the first operating system may be a game scenario, and the second user scenario determined by the second operating system may be a parking scenario.

Step S240. Determine a second resource status of the second operating system.

In an implementation, step S240 may be performed by the second operating system through calling a processor. After determining the second resource status, the second operating system may send the second resource status to the first operating system through an IPC interface.

In an implementation, the second resource status includes a load status of the second operating system, such as a current load. In specific implementation, a performance management tool or a load monitoring tool may run on the second operating system to monitor and obtain the load status of the second operating system. For example, the load status of the second operating system may include CPU usage, GPU usage, NPU usage, memory usage, disk usage, and network usage of the second operating system.

In an implementation, the second resource status may also include load changes of the second operating system in a future period of time. The future period of time may be, for example, a few seconds or minutes in the future, which is not limited in this embodiment of this disclosure. In specific implementation, load changes of the second operating system may be estimated based on the second user scenario of the second operating system, to predict the load changes of the second operating system during the future period of time.

For content of determining the second resource status by the second operating system that is not described, please refer to the manner of determining the first resource status by the first operating system, and details are not described herein.

Step S250. Determine the resource scheduling strategy based on the first user scenario, the second user scenario, the first resource status, and the second resource status.

Step S250 may be performed by either the first operating system through calling the processor or by the second operating system through calling the processor. Alternatively, step S250 may be simultaneously performed by the first operating system and the second operating system through calling the processor. In other words, each of the two operating systems may determine a resource scheduling strategy, separately.

FIG. 5 is a flowchart of step S250 in a resource scheduling method according to an exemplary embodiment of this disclosure.

As shown in FIG. 5, in an embodiment, step S250 may include the following steps.

Step S251. Determine a priority of the first operating system based on the first user scenario, and determine a priority of the second operating system based on the second user scenario.

In an implementation, a priority rule may be set for the user scenarios, which may include priorities of the cockpit system and/or the intelligent driving system in various user scenarios. The priority rule may be flexibly set by a skilled person, which is not limited in this embodiment of this disclosure.

Taking that the priorities include a high priority and a low priority as an example, the priority rule may include the following cases:

When the intelligent driving system and/or the cockpit system is in a driving scenario, an intelligent driving scenario, or a manned driving scenario, the intelligent driving system is set to the high priority and the cockpit system is set to the low priority. In other words, the priority of the intelligent driving system is higher than that of the cockpit system.

When the intelligent driving system is in a parking scenario, while the cockpit system is in a touch scenario, a voice scenario, a visual scenario, a game scenario, a video scenario, a music scenario, and a downloading scenario, the intelligent driving system is set to the low priority and the cockpit system is set to the high priority.

When the intelligent driving system is in a manned driving scenario while the cockpit system is in a navigation scenario, the intelligent driving system is set to the low priority and the cockpit system is set to the high priority.

When the cockpit system is in a standby scenario or a screen-off scenario, the cockpit system is set to the low priority.

When the intelligent driving system is in a standby scenario or a screen-off scenario, the intelligent driving system is set to the low priority.

In this way, the priority of the first operating system and the priority of the second operating system may be determined according to the priority rule.

Taking that the first operating system is the cockpit system and the second operating system is the intelligent driving system as an example, if the first user scenario is the video scenario and the second user scenario is the driving scenario, the first operating system is set to the low priority and the second operating system is set to the high priority.

In an implementation, priorities may also be set for the user scenarios, and the user scenarios may be sorted in a descending or an ascending order according to the priorities.

For example, in a descending order, the priorities of the user scenarios may sequentially include:
a driving scenario>an interaction scenario>an active scenario>a parking scenario>a screen-on scenario>a screen-off scenario.

The driving scenario may include, for example, the intelligent driving scenario and the manned driving scenario. The interaction scenario may include, for example, the touch scenario, the voice scenario, and the visual scenario. The active scenario may include, for example, the game scenario, the video scenario, the music scenario, the navigation scenario, and the downloading scenario.

In this way, based on the foregoing sequence, the priority of the first user scenario may be used as the priority of the first operating system, and the priority of the second user scenario may be used as the priority of the second operating system.

Taking that the first operating system is the cockpit system and the second operating system is the intelligent driving system as an example, if the first user scenario is the video scenario and the second user scenario is the driving scenario, the priority of the first user scenario is lower than that of the second user scenario. Correspondingly, the priority of the first operating system is lower than that of the second operating system.

In an implementation, priority scores may also be preset for a plurality of user scenarios.

For example, the priority scores of the user scenarios may be shown in Table 1.

TABLE 1

| | Priority | | Priority |
|---|---|---|---|
| User scenario | score | User scenario | score |
| Intelligent driving | 99 | Video scenario | 50 |
| scenario | | | |
| Driving scenario | 95 | Music scenario | 50 |
| Manned driving | 90 | Navigation scenario | 50 |
| scenario | | | |
| Interaction scenario | 80 | Downloading | 45 |
| | | scenario | |
| Touch scenario | 80 | Parking scenario | 30 |
| Voice scenario | 80 | Screen-on scenario | 25 |
| Visual scenario | 80 | Standby scenario | 20 |
| Active scenario | 50 | Screen-off scenario | 10 |
| Game scenario | 50 | . . . | . . . |

It should be noted that the foregoing priority scores are only examples and do not constitute specific limitations on this embodiment of this disclosure. A person skilled in the art can make adjustments on the priority scores of various user scenarios based on this embodiment of this disclosure. These adjustments do not go beyond the protection scope of this embodiment of this disclosure.

In this way, a priority relationship between the first operating system and the second operating system may be determined based on the priority scores of the first user scenario and the second user scenario. In other words, the priority score of the first user scenario is used as a priority score of the first operating system, and the priority score of the second user scenario is used as a priority score of the second operating system.

Taking that the first operating system is the cockpit system and the second operating system is the intelligent driving system as an example, if the first user scenario is the video scenario with a priority score of 50 and the second user scenario is the driving scenario with a priority score of 90, the priority of the first user scenario is lower than that of the second user scenario. Correspondingly, the priority of the first operating system is lower than that of the second operating system.

Step S252. Determine the resource scheduling strategy based on the priority of the first operating system, the priority of the second operating system, the first resource status, and the second resource status.

In an implementation, step S252 may be performed according to the followings steps S2521-S2523.

Step S2521. Determine, based on the first resource status, whether there are idle resources in the first operating system; and determine, based on the second resource status, whether there are idle resources in the second operating system.

For example, a load status of the first operating system may be determined by setting a first load threshold. If a current load of the first operating system is greater than (or equal to) the first load threshold, it may be determined that there are no idle resources in the first operating system. If the current load of the first operating system is less than the first load threshold, it may be determined that there are idle resources in the first operating system.

For example, the first load threshold may include a usage threshold of the first operating system on obtained processor resources, such as a CPU usage threshold, a GPU usage threshold, and an NPU usage threshold. Values of the first load threshold may be, for example, 80%, 85%, 88%, 90%, 91%, 92%, 93%, 94%, 95%, 96%, 97%, 98%, or 99%. Usage thresholds corresponding to different processors may be same or different.

For example, the CPU usage threshold is 90%. In this case, if the CPU usage is greater than 90%, it may be determined that there are no idle CPU resources in the first operating system; and if the CPU usage is less than 90%, it may be determined that there are idle CPU resources in the first operating system.

Similarly, a second load threshold may be set for the second operating system, which may be same with or different from the first load threshold. If a current load of the second operating system is greater than (or equal to) the second load threshold, it may be determined that there are no idle resources in the second operating system. If the current load of the second operating system is less than the second load threshold, it may be determined that there are idle resources in the second operating system.

For content of determining whether there are idle resources in the second operating system that is not specifically described, please refer to the manner of determining whether there are idle resources in the first operating system, and details are not described herein.

Step S2522. Determine a first resource scheduling strategy in response to that there are no idle resources in the second operating system and the priority of the first operating system is lower than that of the second operating system, wherein the first resource scheduling strategy includes scheduling the first resources from the first operating system to the second operating system.

There are two situations where there are no idle resources in the second operating system.

One situation is that there are no idle resources in the first operating system, and there are no idle resources in the second operating system either. In this case, it is needed to preferentially ensure that the operating system with the high priority can run stably. Therefore, if the priority of the first operating system is lower than that of the second operating system, the first resources may be scheduled from the first operating system to the second operating system, so that the second operating system can obtain more resources, thereby avoiding insufficient resources and ensuring stable operation of the second operating system.

The other situation is that there are idle resources in the first operating system, but there are no idle resources in the second operating system. In this case, if the priority of the first operating system is lower than that of the second operating system, the first resources may be scheduled from the first operating system to the second operating system, so that the second operating system can obtain more resources, thereby avoiding insufficient resources and ensuring stable operation of the second operating system. Moreover, the idle first resources in the first operating system can be utilized by the second operating system, thereby improving resource utilization.

Step S2523. Determine a second resource scheduling strategy in response to that there are no idle resources in the first operating system and the priority of the first operating system is higher than that of the second operating system, wherein the second resource scheduling strategy includes scheduling the first resources from the second operating system to the first operating system.

There are two situations where there are no idle resources in the first operating system.

One situation is that there are no idle resources in the first operating system, and there are no idle resources in the second operating system either. In this case, it is needed to preferentially ensure that the operating system with the high priority can run stably. Therefore, if the priority of the first operating system is higher than that of the second operating system, the first resources may be scheduled from the second operating system to the first operating system, so that the first operating system can obtain more resources, thereby avoiding insufficient resources and ensuring stable operation of the first operating system.

The other situation is that there are idle resources in the second operating system, but there are no idle resources in the first operating system. In this case, if the priority of the first operating system is higher than that of the second operating system, the first resources may be scheduled from the second operating system to the first operating system, so that the first operating system can obtain more resources, thereby avoiding insufficient resources and ensuring stable operation of the first operating system. Moreover, the idle first resources in the second operating system can be utilized by the first operating system, thereby improving resource utilization.

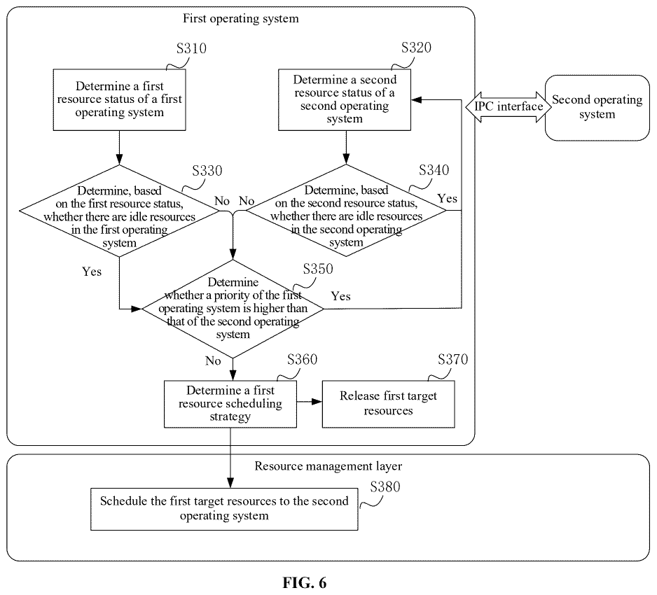

FIG. 6 is a decision flowchart of a first scheduling strategy according to an exemplary embodiment of this disclosure.

In an implementation, the first scheduling strategy may be decided by the first operating system, for example, may include the following steps S310 to S360.

Step S310. Determine the first resource status of the first operating system.

Step S310 may be performed with reference to step S210, and details are not described herein. After determining the first resource status, the first operating system may send the first resource status to the second operating system through the IPC interface.

Step S320. Determine the second resource status of the second operating system.

For example, the first operating system may receive the second resource status sent by the second operating system through the IPC interface.

Step S330. Determine, based on the first resource status, whether there are idle resources in the first operating system.

Step S330 may be performed with reference to step S2521, and details are not described herein.

After the first operating system determines whether there are idle resources, it may proceed to step S350.

Step S340. Determine, based on the second resource status, whether there are idle resources in the second operating system.

Step S340 may be performed with reference to step S2521, and details are not described herein. If there are no idle resources in the second operating system, it may proceed to step S350. If there are idle resources in the second operating system, it may proceed to step S320.

Step S350. Determine whether the priority of the first operating system is higher than that of the second operating system.

If the priority of the first operating system is higher than that of the second operating system, it may proceed to step S320. To be specific, if the priority of the first operating system is higher than that of the second operating system, although there are no idle resources in the second operating system, the first operating system would not determine the first resource scheduling strategy, so that the first resources would not be scheduled from the operating system with high-priority to the operating system with low priority.

If the priority of the first operating system is lower than that of the second operating system, it may proceed to step S360.

Step S360. Determine the first resource scheduling strategy.

To be specific, if the priority of the first operating system is lower than that of the second operating system, regardless of whether there are idle resources in the first operating system, the first operating system may determine the first scheduling strategy, so that the first resources may be scheduled from the first operating system low priority to the second operating system with high priority.

Subsequently, after the first resource scheduling strategy being determined, the first resource scheduling strategy may be executed to complete the resource scheduling. Manners for executing the first resource scheduling strategy are exemplarily described below.

In an implementation, the first resource scheduling strategy may be executed by the first operating system and the resource management layer through calling processors. As shown in FIG. 6, execution of the first resource scheduling method may include steps S370 and S380.

Step S370. Release, based on resource demands of the second operating system, first target resources from the first resources that are already obtained by the first operating system, where the first target resources match the resource demands of the second operating system.

Step S370 may be performed by the first operating system through calling the processor.

In an example, if the second operating system has requirements for resources, the second operating system may send the resource demands to the first operating system through the IPC interface. In other words, the first operating system may receive the resource demands from the second operating system through the IPC interface. The resource demands of the second operating system may include a resource type required by the second operating system and a corresponding resource demand quantity.

The resource type may include, for example, CPU resources, GPU resources, NPU resources, and storage resources. The resource demand quantity may include, for example, a demand quantity of CPU resources, a demand quantity of GPU resources, and a demand quantity of NPU resources.

In an implementation, the second operating system may predict, based on the second user scenario, resources required by the second operating system during the future period of time, to determine the resource demands of the second operating system. Subsequently, the resource demands of the second operating system are sent to the first operating system.

Taking that the second operating system as the intelligent driving system and the second user scenario is the intelligent driving scenario as an example, it is assumed that NPU resources currently obtained by the second operating system are 200 TOPS (Tera operations per second), f NPU resources required by the intelligent driving application on an urban elevated road are 150 TOPS, and NPU resources required by the intelligent driving application on an urban mixed-traffic road are 250 TOPS. In this case, when the vehicle drives from the urban elevated road to the urban mixed-traffic road, the second operating system needs to obtain at least 50 TOPS of NPU resources again to meet requirements for computing power of the intelligent driving application. In other words, during the future period of time, such as during a remaining duration before reaching a destination of this intelligent driving, the resource demands of the second operating system include at least 50 TOPS of NPU resources.

After obtaining the resource demands of the second operating system, the first operating system may determine whether idle resources in the first resources that have already been obtained by the first operating system (first idle resources for short below) match the resource demands of the second operating system.

For example, it may be determined whether a type of the first idle resources matches the resource type required by the second operating system. For example, if the type of the first idle resources is same as the resource type required by the second operating system, it means that the type of the first idle resources matches the resource type required by the second operating system. If the type of the first idle resources is different from the resource type required by the second operating system, it means that the type of the first idle resources does not match the resource type required by the second operating system.

For example, if the first idle resources include CPU resources while the second operating system requires NPU resources, the type of the first idle resources does not match the resource type required by the second operating system. If the first idle resources include CPU resources and the second operating system also requires CPU resources, the type of the first idle resources matches the resource type required by the second operating system.

For example, it may also be determined whether a resource quantity of the first idle resources matches a required resources quantity of the second operating system. For example, if the resource quantity of the first idle resources is greater than or equal to a resource demand quantity for a same type of resources of the second operating system, it means that the resource quantity of the first idle resources matches the resource demand quantity of the second operating system. If the resource quantity of the first idle resources is less than a resource demand quantity for a same type of resources of the second operating system, it means that the resource quantity of the first idle resources does not match the resource demand quantity of the second operating system.

For example, if the first idle resources include 200 TOPS of NPU resources and the second operating system requires 100 TOPS of NPU resources, the resource quantity of the first idle resources matches the resource demand quantity of the second operating system. If the first idle resources include 200 TOPS of NPU resources while the second operating system requires 300 TOPS of NPU resources, the resource quantity of the first idle resources does not match the resource demand quantity of the second operating system.

Therefore, if the resource type and the resource quantity of the first idle resources match the resource type and the resource demand quantity of the second operating system, it may be determined that the first idle resources match the resource demands of the second operating system. Otherwise, it may be determined that the first idle resources do not match the resource demands of the second operating system.

In an example, the resource demands of the second operating system may also include resource demand duration of the second operating system. The resource demand duration may be preset duration, or may be remaining duration predicted for a current user scenario of the second operating system.

For example, it may also be determined whether remaining idle duration of the first idle resources matches the resource demand duration of the second operating system. If the remaining idle duration of the first idle resources is greater than or equal to the resource demand duration of the second operating system, it means that the remaining idle duration of the first idle resources matches the resource demand duration of the second operating system. If the remaining idle duration of the first idle resources is less than the resource demand duration of the second operating system, it means that the remaining idle duration of the first idle resources does not match the resource demand duration of the second operating system.

In this case, if the resource type, the resource quantity, and the remaining idle duration of the first idle resources all match the resource type, the resource demand quantity, and the resource demand duration of the second operating system, it may be determined that the first idle resources match the resource demands of the second operating system. Otherwise, it may be determined that the first idle resources do not match the resource demands of the second operating system.

Subsequently, when the first idle resources match the resource demands of the second operating system, the first operating system may release the first target resources from the first idle resources, making the first target resources in an unallocated status. In other words, the released first target resources do not belong to either the first operating system or the second operating system. In some implementations, the first target resources may also be released by the resource management layer, which is not specifically limited herein.

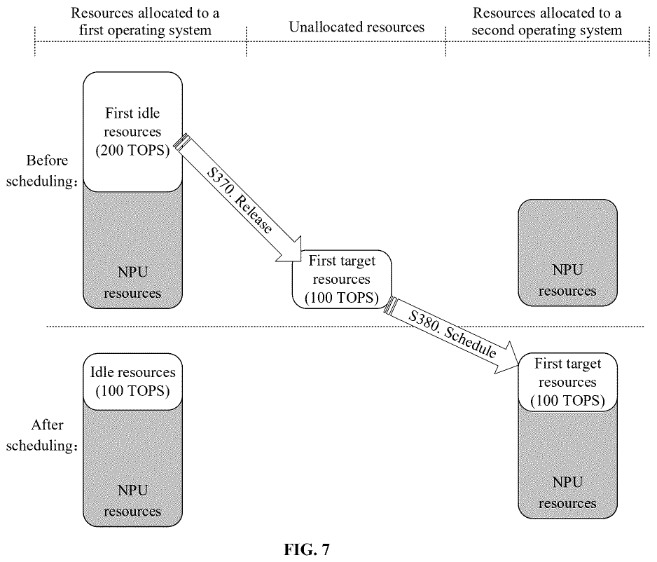

For example, as shown in FIG. 7, if the first idle resources include 200 TOPS of NPU resources and the second operating system requires 100 TOPS of NPU resources, the first operating system may release 100 TOPS of NPU resources from the first idle resources. Certainly, the first operating system may also release more NPU resources, such as 150 TOPS of NPU resources, from the first idle resources, so that more NPU resources can be scheduled to the second operating system later.

In addition, when the first idle resources do not match the resource demands of the second operating system, the first operating system may perform internal resource scheduling to obtain the idle first target resources, and then release the first target resources.

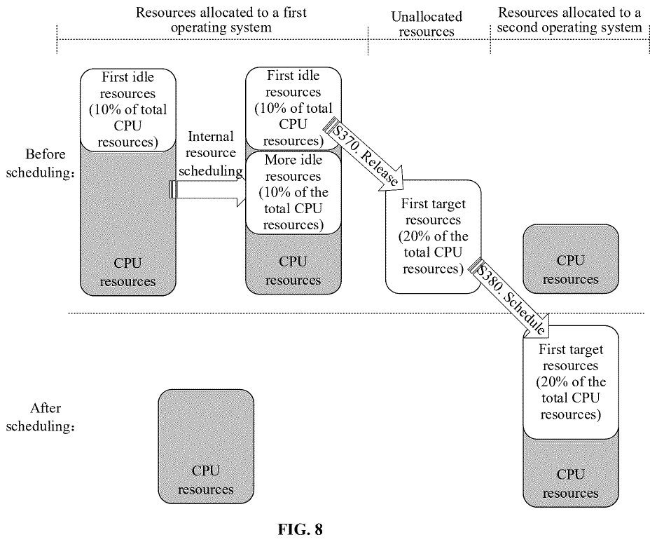

For example, the first operating system may perform the internal resource scheduling based on the first user scenario. As shown in FIG. 8, for example, the first operating system is the cockpit system, and the first user scenario is the video scenario. If the first idle resources include 10% of the total CPU resources while the second operating system requires 20% of the total CPU resources, the first operating system may reduce utilization of the video application for the CPU resources by lowering parameters such as a bitrate, resolution, and a frame rate of a video, thereby freeing up more CPU resources. For example, other 10% of the total CPU resources are freed up. In this way, together with the original first idle resources, a total of 20% of the total CPU resources may be freed up to serve as the first target resources, which may be released.

Similarly, if the first user scenario is the game scenario, picture quality of a game may be reduced, for example, a frame rate, resolution, and the picture quality of the game may be lowered, and game animations may be reduced or turned off, so as to reduce resources occupied by the game application, thereby obtaining more idle resources. If the first user scenario is the downloading scenario, a download speed of an application may be reduced or a download task may be paused to reduce resources occupied by the download task, thereby obtaining more idle resources.

In addition, the first operating system may also control a background task, such as close the background task or reduce resources allocated to background task, thereby obtaining more idle resources. Closing the background task may include, for example, closing a background application that has not been used by the user for a long time, or close a background update task or a download task.

Manners for the operating system to free up more resources are not specifically limited in this embodiment of this disclosure.

Step S380. Schedule the first target resources to the second operating system.

In an implementation, step S380 may be performed by the resource management layer through calling a processor.

In an example, after releasing the first target resources, the first operating system may also send a first notification message to the resource management layer, wherein the first notification message instructs the resource management layer to execute the first resource scheduling strategy. In this way, the resource management layer may schedule the first target resources to the second operating system when receiving the first notification message. The first notification message may include, for example, the first resource scheduling strategy and a scheduled object, such as the first target resources, to instruct the resource management layer to schedule the first target resources to the second operating system.

For example, the first operating system may send the first notification message to a virtual machine manager hypervisor. After receiving the first notification message, the virtual machine manager hypervisor schedules the released first target resources to the second operating system.

For example, as shown in FIG. 7, after releasing 100 TOPS of NPU resources, the first operating system may send the first notification message to the virtual machine manager hypervisor, to instruct the virtual machine manager hypervisor to schedule the 100 TOPS of NPU resources to the second operating system. After receiving the first notification message, the virtual machine manager hypervisor performs resource scheduling and schedules the 100 TOPS of NPU resources to the second operating system.

For example, as shown in FIG. 8, after releasing 20% of the total CPU resources, the first operating system may send the first notification message to the virtual machine manager hypervisor, to instruct the virtual machine manager hypervisor to schedule the 20% of the total CPU resources to the second operating system. After receiving the first notification message, the virtual machine manager hypervisor performs resource scheduling and schedules the 20% of the total CPU resources to the second operating system.

In an implementation, a second scheduling strategy may be decided by the second operating system, and the second resource scheduling strategy may be executed by the second operating system and the resource management layer. The decision of the second scheduling strategy by the second operating system may be implemented with reference to the decision of the first scheduling strategy by the first operating system. The execution of the second scheduling strategy by the second operating system and the resource management layer may be implemented with reference to the execution of the first scheduling strategy by the first operating system and the resource management layer. Details are not described herein.

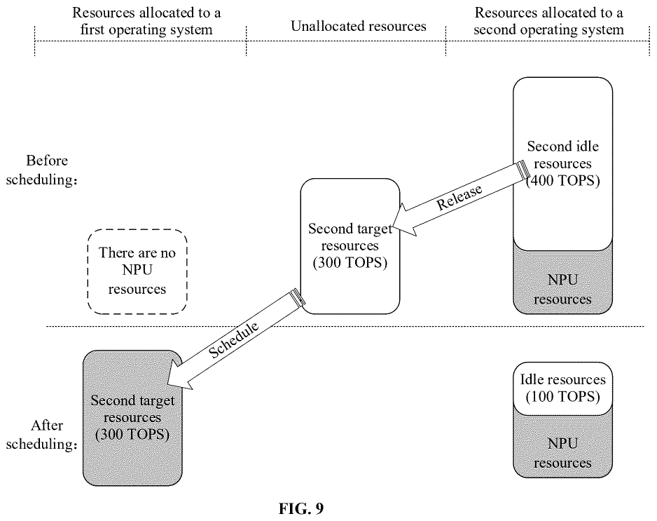

For example, as shown in FIG. 9, the first operating system is the cockpit system, the first user scenario is the voice scenario, the second operating system is the intelligent driving system, and the second user scenario is the parking scenario.

Generally, the intelligent driving task needs to be executed in the second operating system. Therefore, most or all of the NPU resources may be allocated to the second operating system by default, while the first operating system can only obtain a small quantity of the NPU resources or does not obtain the NPU resources. This indicates that when the second user scenario is the parking scenario, the second operating system may have a large quantity of idle NPU resources.

Meanwhile, when the first user scenario is the voice scenario, a speech recognition application of the first operating system may be required to rely on a large local model to understand speech content input by the user and provide corresponding responses. This indicates that the first operating system requires a large quantity of NPU resources to meet requirements for computing power of the local large model. In this case, the idle NPU resources (that is, second idle resources) in the second operating system may be released to be scheduled to the first operating system.

For example, if the second idle resources include 400 TOPS of NPU resources and the resource demands of the first operating system are 300 TOPS of NPU resources, the second operating system may release 300 TOPS of NPU resources from the second idle resources. Certainly, the second operating system may also release more NPU resources from the second idle resources, for example, may release 350 TOPS of NPU resources or may release 400 TOPS of NPU resources, that is, release all the idle NPU resources.

After releasing 300 TOPS of NPU resources, the second operating system may send a second notification message to the virtual machine manager hypervisor, to instruct the virtual machine manager hypervisor to schedule the 300 TOPS of NPU resources to the first operating system. After receiving the second notification message, the virtual machine manager hypervisor performs resource scheduling and schedules the 300 TOPS of NPU resources to the first operating system.

It may be learned from the foregoing technical solutions that, according to method provided in the embodiments of this disclosure, resource scheduling can be performed between different operating systems based on the resource demands of each operating system in different user scenarios. In other words, cross-system resource scheduling based on the user scenarios is implemented, which not only meets the resource demands of each operating system in different user scenarios, thereby improving operational stability of the operating system; but also makes resource allocation more reasonable, thereby improving resource utilization.

### Exemplary Apparatus

The resource scheduling method provided in embodiments of this disclosure is described above. It may be understood that, to implement the foregoing functions, a cockpit-integrated driving system (such as a first operating system, a second operating system, and a resource management layer in the cockpit-integrated driving system) includes corresponding software modules for implementing the various functions.

Certainly, a person skilled in the art should easily conceive that, in combination with the steps in the resource scheduling method that are described in the embodiments of this disclosure, this disclosure can be implemented in a form of hardware or a combination of hardware and computer software. Whether a certain function is implemented in a form of hardware or software-driven hardware depends on specific application and design constraints of the technical solutions. A person skilled in the art may use different methods to implement the described functions for each specific application, but such implementation should not be considered beyond the scope of this disclosure.

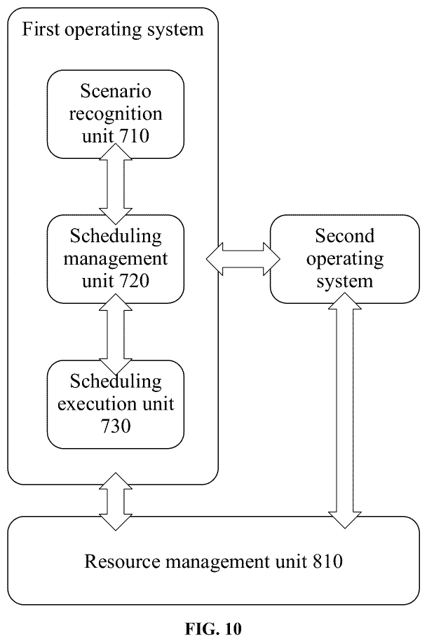

FIG. 10 is a block diagram of a structure of a resource scheduling apparatus according to an exemplary embodiment of this disclosure.

An embodiment of this disclosure provides a resource scheduling apparatus, which is applied to an integrated circuit that runs at least a first operating system and a second operating system.

In an embodiment, as shown in FIG. 10, the resource scheduling apparatus for implementing various steps of the resource scheduling method described above may include a scenario recognition unit 710, a scheduling management unit 720, and a scheduling execution unit 730. Functions of each unit may be implemented in the first operating system and/or the second operating system. Taking that the functions of each unit are implemented in the first operating system as an example:

The scenario recognition unit 710 is configured to determine a first user scenario for the first operating system, and send the first user scenario to the scheduling management unit 720. For example, the scenario recognition unit 710 may determine the first user scenario based on information of an application currently running in the first operating system.

The scheduling management unit 720 is configured to determine a resource scheduling strategy based on the first user scenario.

In an implementation, the scenario recognition unit 710 is configured to determine a first resource status of the first operating system, and send the first resource status to the scheduling management unit 720. The scheduling management unit 720 is configured to determine the resource scheduling strategy based on the first user scenario and the first resource status.

In an implementation, the scheduling management unit 720 is configured to, for example, communicate with the second operating system through an IPC interface, to obtain a second user scenario and a second resource status of the second operating system; and determine the resource scheduling strategy based on the first user scenario, the second user scenario, the first resource status, and the second resource status.

In an implementation, the scheduling management unit 720 is configured to determine a priority of the first operating system based on the first user scenario, and determine a priority of the second operating system based on the second user scenario; and determine the resource scheduling strategy based on the priority of the first operating system, the priority of the second operating system, the first resource status, and the second resource status.

In an implementation, the scheduling management unit 720 is configured to determine, based on the first resource status, whether there are idle resources in the first operating system; determine, based on the second resource status, whether there are idle resources in the second operating system; and determine a first resource scheduling strategy in response to that there are no idle resources in the second operating system and the priority of the first operating system is lower than that of the second operating system, wherein the first resource scheduling strategy includes scheduling the first resources from the first operating system to the second operating system.

In an implementation, the scheduling management unit 720 is configured to obtain resource demands of the second operating system; and when idle resources in the first resources that are already obtained by the first operating system do not meet the resource demands of the second operating system, determine an internal scheduling strategy of the first operating system and send the same to the scheduling execution unit 730. The scheduling execution unit 730 is configured to execute the internal scheduling strategy of the first operating system and schedule internal resources of the first operating system to obtain idle first target resources.

In an implementation, the scheduling execution unit 730 is further configured to release the first target resources, so that the first target resources are in an unallocated status.

In an implementation, the resource scheduling apparatus also includes a resource management unit 810.

The scheduling management unit 720 is configured to send the resource scheduling strategy (such as the first resource scheduling strategy) to the resource management unit 810. The resource management unit 810 may be configured to execute the resource scheduling strategy for cross-system resource scheduling, for example, execute the first resource scheduling strategy to schedule the first target resources to the second operating system.

In an implementation, the resource management unit 810 is configured to release the first target resources, so that the first target resources are in an unallocated status. In other words, the first target resources may be released by either the scheduling execution unit 730 or the resource management unit 810.

In an implementation, the scheduling management unit 720 is configured to predict, based on the first user scenario, resources required by the first operating system in future preset duration to determine resource demands of the first operating system.

In an implementation, the scheduling management unit 720 is configured to send the first user scenario, the first resource status, and the resource demands of the first operating system to the second operating system.

In an implementation, functions of any unit in the resource scheduling apparatus may be implemented by a plurality of units cooperating with each other. In other words, the resource scheduling apparatus may include more units. For example, the resource scheduling apparatus may also include a cross-domain scheduling unit, and at least some of the functions of the scheduling management unit 720 may be implemented by the cross-domain scheduling unit.

For example, the scheduling management unit 720 is configured to send the first user scenario and the first resource status to the cross-domain scheduling unit, or the scenario recognition unit 710 may also send the first user scenario and the first resource status to the cross-domain scheduling unit. The cross-domain scheduling unit is configured to determine the resource scheduling strategy based on the first user scenario and the first resource status.

For example, the cross-domain scheduling unit is configured to communicate with the second operating system to obtain the second user scenario and the second resource status of the second operating system; and determine the resource scheduling strategy based on the first user scenario, the second user scenario, the first resource status, and the second resource status.

For example, the cross-domain scheduling unit is configured to obtain the resource demands of the second operating system, and send the resource scheduling strategy and the resource demands of the second operating system to the scheduling management unit 720. In this way, the scheduling management unit 720 may determine the internal scheduling strategy of the first operating system based on the resource scheduling strategy and the resource demands of the second operating system.

For example, the cross-domain scheduling unit may also be configured to send the resource scheduling strategy (such as the first resource scheduling strategy) to the resource management unit 810, so that the resource management unit 810 executes the resource scheduling strategy.

In an implementation, the functions of the plurality of units in the resource scheduling apparatus may also be implemented in one unit. For example, at least two units in the scenario recognition unit 710, the scheduling management unit 720, and the scheduling execution unit 730 are combined into one unit. In other words, the resource scheduling apparatus may include fewer units, which all do not go beyond the protection scope of this embodiment of this disclosure.

In addition, in the first operating system or the second operating system, each unit of the resource scheduling apparatus may be implemented in various ways. This is not limited in this embodiment of this disclosure. Taking that the first operating system is an Android system as an example: the scenario recognition unit 710 may be located at an application framework layer of the Android system, the scheduling management unit 720 may be located at a native layer of the Android system, the scheduling execution unit 730 may be located at a kernel layer of the Android system, and the resource management unit 810 may be located at a resource management layer of a cockpit-integrated driving system. For example, the resource management unit 810 may be a virtual machine manager hypervisor at the resource management layer.

According to resource scheduling apparatus provided in this embodiment of this disclosure, resource scheduling can be performed between different operating systems based on the resource demands of each operating system in different user scenarios. In other words, cross-system resource scheduling based on the user scenarios is implemented, which not only meets the resource demands of each operating system in different user scenarios, thereby improving operational stability of the operating system; but also makes resource allocation more reasonable, thereby improving resource utilization.

### Exemplary Electronic Device

An embodiment of this disclosure provides an electronic device that may be applied in vehicles, such as in an intelligent connected car. The electronic device may be, for example, a vehicle-mounted computing device, a vehicle-mounted computing platform, a vehicle-mounted computing unit, or an intelligent driving computing platform.

In an embodiment, the electronic device may include a chip system provided in the embodiments of this disclosure. The chip system may run at least one operating system, such as an intelligent driving system and a cockpit system, to implement relevant functions of a cockpit-integrated driving system.

In an embodiment, the electronic device may further include:
a housing for accommodating and mounting various hardware units of the electronic device, to protect the hardware units from dust and water immersion, thereby improving reliability of the electronic device;
a power module for supplying power to various hardware units of the electronic device;
a heat dissipation module, such as a cooling fan or a liquid cooling device, which is configured to dissipate heat from the hardware units of the electronic device, so as to reduce operating temperature of each hardware unit and improve operational stability of each hardware unit; and
an external interface for connecting various sensors on the vehicle, such as a camera, a laser radar, a millimeter wave radar, and an ultrasonic radar, to send instructions to the sensors or receive data returned by the sensors. The external interface may also connect various actuators of the vehicle, such as a driving system, a braking system, and a steering system, to send control instructions to the systems and receive feedback from the systems.

### Exemplary Vehicle

An embodiment of this disclosure provides a vehicle, which may include a land vehicle, an aerial vehicle, a maritime vehicle, an underwater vehicle, a space vehicles, and the like. For details of specific content of the vehicle, reference may be made to the foregoing embodiments, and details are not described herein again.

The vehicle may include a chip system or an electronic device provided in the embodiments of this disclosure, so as to implement the resource scheduling method provided in the embodiments of this disclosure. In this way, when users use the vehicle, such as drive the vehicle or use the vehicle to watch videos, listen to music, or play games, the vehicle may perform cross-system resource scheduling between a cockpit system and an intelligent driving system based on user scenarios, providing the users with better user experience.

### Exemplary Computer Program Product and Computer Readable Storage Medium

In addition to the foregoing method and device, embodiments of this disclosure may also relate to a computer program product, which includes computer program instructions. When the computer program instructions are run by a processor, the processor is enabled to perform the steps, of the resource scheduling method according to the embodiments of this disclosure, that are described in the “Exemplary method” section of this specification.

The computer program product may be program code, written with one or any combination of a plurality of programming languages, that is configured to perform the operations in the embodiments of this disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of this disclosure may further relate to a computer readable storage medium, which stores computer program instructions. When the computer program instructions are run by the processor, the processor is enabled to perform the steps, of the resource scheduling method according to the embodiments of this disclosure, that are described in the “Exemplary method” section of this specification.

The computer readable storage medium may be one readable medium or any combination of a plurality of readable media. The readable medium may be a readable signal medium or a readable storage medium. The readable storage medium may include, for example but is not limited to electricity, magnetism, light, electromagnetism, infrared ray, or a semiconductor system, an apparatus, or a device, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above.

Basic principles of this disclosure are described above in combination with specific embodiments. However, it should be pointed out that the advantages, superiorities, and effects mentioned in this disclosure are merely examples but are not for limitation, and it cannot be considered that these advantages, superiorities, and effects are necessary for each embodiment of this disclosure. In addition, specific details described above are merely for examples and for ease of understanding, rather than limitations. The details described above do not limit that this disclosure must be implemented by using the foregoing specific details.

A person skilled in the art may make various modifications and variations to this disclosure without departing from the spirit and the scope of this application. In this way, if these modifications and variations of this application fall within the scope of the claims and equivalent technologies of the claims of this disclosure, this disclosure also intends to include these modifications and variations.

What is claimed is:

1. A resource scheduling method for an integrated circuit, wherein the integrated circuit runs at least a first operating system and a second operating system, and the method comprises:
determining a first user scenario for the first operating system; and
determining, based on the first user scenario, a resource scheduling strategy for scheduling first resources between the first operating system and the second operating system, wherein the first resources comprise resources shared by the first operating system and the second operating system.

2. The method according to claim 1, wherein
the first operating system is a cockpit system, and the second operating system is an intelligent driving system.

3. The method according to claim 1, wherein the determining, based on the first user scenario, a resource scheduling strategy for scheduling first resources between the first operating system and the second operating system comprises:
determining a first resource status of the first operating system; and
determining, based on the first user scenario and the first resource status, the resource scheduling strategy.

4. The method according to claim 3, wherein the method further comprises:
determining a second user scenario for the second operating system;
determining a second resource status of the second operating system; and
determining the resource scheduling strategy based on the first user scenario, the second user scenario, the first resource status, and the second resource status.

5. The method according to claim 4, wherein the determining the resource scheduling strategy based on the first user scenario, the second user scenario, the first resource status, and the second resource status comprises:
determining, based on the first user scenario, a priority of the first operating system, and determining, based on the second user scenario, a priority of the second operating system; and
determining the resource scheduling strategy based on the priority of the first operating system, the priority of the second operating system, the first resource status, and the second resource status.

6. The method according to claim 5, wherein the determining the resource scheduling strategy based on the priority of the first operating system, the priority of the second operating system, the first resource status, and the second resource status comprises:
determining, based on the second resource status, whether there are idle resources in the second operating system; and
determining a first resource scheduling strategy in response to that there are no idle resources in the second operating system and the priority of the first operating system is lower than that of the second operating system, wherein the first resource scheduling strategy comprises scheduling the first resources from the first operating system to the second operating system.

7. The method according to claim 6, wherein the method further comprises:
releasing, based on resource demands of the second operating system, first target resources from the first resources that are already obtained by the first operating system, wherein the first target resources match the resource demands of the second operating system; and
scheduling the first target resources to the second operating system.

8. The method according to claim 7, further comprising:
in response to that idle resources in the first resources already obtained by the first operating system do not match the resource demands of the second operating system, performing internal resource scheduling on the first operating system to obtain idle first target resources.

9. The method according to claim 7, further comprising:
predicting, based on the second user scenario, resources required by the second operating system in future preset duration to determine the resource demands of the second operating system.

10. The method according to claim 6, further comprising:
determining, based on the first resource status, whether there are idle resources in the first operating system; and
determining a second resource scheduling strategy in response to that there are no idle resources in the first operating system and the priority of the first operating system is higher than that of the second operating system, wherein the second resource scheduling strategy comprises scheduling the first resources from the second operating system to the first operating system.

11. The method according to claim 10, wherein the method further comprises:
releasing, based on resource demands of the first operating system, second target resources from the first resources that are already obtained by the second operating system, wherein a resource quantity of the second target resources matches the resource demands of the first operating system; and
scheduling the second target resources to the first operating system.

12. The method according to claim 11, further comprising:
when a quantity of idle resources in the first resources that are already obtained by the second operating system is less than the resource quantity of the second target resources, performing internal resource scheduling on the second operating system to obtain idle second target resources.

13. The method according to claim 11, further comprising:
predicting, based on the first user scenario, resources required by the first operating system in future preset duration to determine the resource demands of the first operating system.

14. The method according to claim 4, wherein
the determining a first user scenario for the first operating system comprises:
determining, based on information of an application currently running on the first operating system, the first user scenario; and
the determining a second user scenario for the second operating system comprises:
determining, based on information of an application currently running on the second operating system, the second user scenario.

15. The method according to claim 1, wherein the first operating system communicates with the second operating system through an inter-process communication interface.

16. A chip system, comprising a memory and a processor, wherein the memory stores computer program instructions, and when the computer program instructions are executed by the processor, the chip system is enabled to perform steps of a resource scheduling method, wherein the method comprises:
determining a first user scenario for the first operating system; and
determining, based on the first user scenario, a resource scheduling strategy for scheduling first resources between the first operating system and the second operating system, wherein the first resources comprise resources shared by the first operating system and the second operating system.

17. The chip system according to claim 16, wherein
the first operating system is a cockpit system, and the second operating system is an intelligent driving system.

18. The chip system according to claim 16, wherein the determining, based on the first user scenario, a resource scheduling strategy for scheduling first resources between the first operating system and the second operating system comprises:
determining a first resource status of the first operating system; and
determining, based on the first user scenario and the first resource status, the resource scheduling strategy.

19. The chip system according to claim 18, wherein the method further comprises:
determining a second user scenario for the second operating system;
determining a second resource status of the second operating system; and
determining the resource scheduling strategy based on the first user scenario, the second user scenario, the first resource status, and the second resource status.

20. An electronic device, comprising a chip system, wherein the chip system comprises a memory and a processor, wherein the memory stores computer program instructions, and when the computer program instructions are executed by the processor, the chip system is enabled to perform steps of a resource scheduling method, wherein the method comprises:
determining a first user scenario for the first operating system; and
determining, based on the first user scenario, a resource scheduling strategy for scheduling first resources between the first operating system and the second operating system, wherein the first resources comprise resources shared by the first operating system and the second operating system.
